(19) United States
(12) Patent Application Publication
(10) Pub. No.: US 2025/0214162 A1
(43) Pub. Date: Jul. 3, 2025

(54) SUPPORT PLATE ADJUSTMENT STRUCTURE OF VERTICAL BAND SAW MACHINE

(71) Applicant: KING SAW MACHINERY LTD., Taichung City (TW)

(72) Inventor: Chin-Feng Chang, Taichung City (TW)

(21) Appl. No.: 18/402,743

(22) Filed: Jan. 3, 2024

(51) Int. Cl. B23D 55/04

(52) U.S. Cl. CPC B23D 55/04

(57) ABSTRACT

A support plate adjustment structure of a vertical band saw machine includes a workbench and a support unit. The workbench includes a rail seat fixedly connected to the workbench, a linear slide rail on the rail seat, and a slide slidably connected to the linear slide rail. A retaining plate assembly is provided between the workbench and the rail seat. The retaining plate assembly includes a first retaining plate and a second retaining plate. The support unit includes a support plate and a connecting seat connected to the slide. The support plate is connected on the connecting seat. The connecting seat can be locked or unlocked. The structure enables the support plate to be more stable, without wobble, and has better applicability.

### BACKGROUND OF THE PRESENT INVENTION

### Field of Invention

The present invention relates to a support plate adjustment structure of a vertical band saw machine, and more particularly to a support plate adjustment structure that makes a support plate more stable and ensures accuracy and is applicable to different workbenches.

### Description of Related Arts

FIG. 1 and FIG. 2 illustrates a conventional vertical band saw machine. The vertical band saw machine 10 has an upper machine frame 11, a lower machine frame 12, and a workbench 13 between the upper machine frame 11 and the lower machine frame 12. The vertical band saw machine 10 includes a ring-shaped metal band saw blade 24 driven by power and passing through the upper machine frame 11, the workbench 13 and the lower machine frame 12. A round rod-shaped guide rail 15 is fixedly connected to the front side edge of the workbench 13. A support plate 17 having a sliding sleeve 16 is provided on the workbench 13. The sliding sleeve 16 is located on the lower edge of one side of the support plate 17. The sliding sleeve 16 has a through hole 161 perpendicular to the axial direction of the support plate 17. A positioning screw hole 162 perpendicular to the axial direction of the through hole 161 is formed at the outer center of the sliding sleeve 16. The through hole 161 of the sliding sleeve 16 is configured for receiving the guide rail 15, so that the support plate 17 can slide freely on the workbench 13 to adjust the distance between the support plate 17 and the annular metal band saw blade 14. The positioning screw hole 162 is configured for locking a positioning bolt 18. The positioning bolt 18 passes through the through hole 161 and is against the periphery of the guide rail 15, so that the support plate 17 can be positioned on the workbench 13 for the workpiece to be cut. However, the position of the support plate 17 needs to be adjusted accurately in order to improve the accuracy of cutting the workpiece. When the support plate 17 is to be adjusted, the positioning bolt 18 is unscrewed, and the position of the support plate 17 is slowly adjusted by pulling the sliding sleeve 16 to slide on the guide rail 15 in a manual manner. However, this requires the user's professionalism and working experience for adjusting the position of the support plate 17 quickly and accurately. It takes time and is not easy for unskilled users to adjust the support plate 17 to a precise position. For the sliding sleeve 16 to be adjusted easily in a manual manner, the inner diameter of the through hole 161 is slightly greater than the outer diameter of the guide rail 15, which results in a gap S between the sliding sleeve 16 and the guide rail 15. After the support plate 17 is adjusted to the precise position, the positioning bolt 18 is screwed tightly and one end of the positioning bolt 18 is against the periphery of the guide rail 15 to position the sliding sleeve 16. However, the positioning bolt 18 is only against the guide rail 15 in a point manner, so the two ends of the sliding sleeve 16 easily wobble within the range of the gap S. As a result, the support plate 17 connected to the sliding sleeve 16 tilts or swings, which reduces the accuracy greatly and needs improvement.

In addition, the guide rail 15 is secured to the front side edge of the workbench 13 with locking holes. Therefore, the guide rail 15 is specially made for the workbench 13 of the vertical band saw machine 10. In other words, when the slide rail 15 is to be installed on a different type of workbench 13, it may need to be manufactured separately due to different positions of locking holes. Therefore, there is a problem that the guide rail 15 cannot be applied to other different workbenches 13.

### SUMMARY OF THE PRESENT INVENTION

In view of the shortcomings of the prior art, the primary object of the present invention is to provide a support plate adjustment structure of a vertical band saw machine. A slide is pressed against a linear slide rail in a “plane” manner, so that a support plate is more stable and does not wobble, achieving better accuracy of the workpiece. A retaining plate assembly composed of a first retaining plate and a second retaining plate is applicable to different types of workbenches.

Another object of the present invention is to provide a mechanical fine adjustment unit connected to the support plat to achieve the effect of quick and precise adjustment of the support plate.

In order to achieve the foregoing objects, the present invention provides a support plate adjustment structure of a vertical band saw machine, comprising a workbench and a support unit. The workbench includes a rail seat fixedly connected to a front side edge of the workbench, a linear slide rail on the rail seat, and a slide slidably connected to the linear slide rail. A front side edge of the rail seat has a serrate portion. A retaining plate assembly is provided between the workbench and the rail seat. The front side edge of the workbench has at least two connecting screw holes. The retaining plate assembly includes an L-shaped first retaining plate and an L-shaped second retaining plate. The first retaining plate has a plurality of first elongated vertical holes that are arranged in sequence and a plurality of first elongated horizontal holes that are arranged in sequence. The second retaining plate has at least one second elongated vertical hole and at least one second elongated horizontal hole. The rail seat is disposed on the first elongated horizontal holes and the second elongated horizontal hole. The serrate portion extends out of an edge of the retaining plate assembly. At least one first transverse bolt passes through a corresponding one of the first elongated vertical holes and is screwed to a corresponding one of the connecting screw holes, so that the first relating plate is fixed to the front side edge of the workbench. A second transverse bolt passes through the second elongated vertical hole and is screwed to a corresponding one of the connecting screw holes, so that the second relating plate is fixed to the front side edge of the workbench. The first retaining plate and the second retaining plate are arranged side by side. At least one first longitudinal bolt passes through a corresponding one of the first elongated horizontal holes and locks the rail seat on the first retaining plate. A second longitudinal bolt passes through the second elongated horizontal hole and locks the rail seat on the second retaining plate. The support unit is connected to the slide. The support unit includes a support plate located above the workbench and a connecting seat connected to the slide. The support plate is connected on the connecting seat. A fine adjustment unit is pivoted under the connecting seat. The fine adjustment unit includes a clutch seat, a worm, and a rotary handle connected to one end of the worm. The clutch seat has a side through hole and an opening facing the serrate portion. A worm wheel is pivoted inside the clutch seat and extends out of the opening. The worm is insertedly connected to the side through hole and meshes with the worm wheel. The clutch seat is pivotally connected to an underside of the connecting seat. The clutch seat is rotatable for the worm wheel to mesh or not to mesh with the serrate portion.

In one embodiment of the present invention, the rail seat has a T-shaped groove parallel to the rail seat. A top of the connecting seat has a positioning hole. A braking plate is horizontally embedded in the T-shaped groove. The braking plate has a plate screw hole. An adjustable handle screw is screwed to the plate screw hole from the top of the connecting seat via the positioning hole for locking and loosening the connecting seat, thereby positioning or releasing the connecting seat.

In one embodiment of the present invention, one side of the connecting seat, parallel to an axial direction of the linear slide rail, has a shaft hole. One side of the clutch seat has a longitudinal perforation. A coupling plate is fixedly connected to a top of the clutch seat. A movable plate is provided on one side of the coupling plate away from the perforation. The movable plate is in an L shape and has a horizontal surface and a vertical surface. The horizontal surface has an elongated movement hole. The vertical surface has an elongated locking hole. A bolt passes through the elongated movement hole and is threadedly connected to the coupling plate. The clutch seat is connected to the underside of the connecting seat in cooperation with a shaft bolt passing through the perforation of the clutch seat. The elongated locking hole corresponds to the shaft hole. A quick-release locking member includes a screw rod, an eccentric rotating handle, and a nut. One end of the screw rod is pivoted to the eccentric rotating handle. Another end of the screw rod passes through the elongated locking hole and the shaft hole of the connecting seat and is locked with the nut. The eccentric rotating handle is pulled to tighten the clutch seat or the eccentric handle is pulled reversely to loosen the clutch seat.

In one embodiment of the present invention, the coupling plate has an elongated restricting hole. Another bolt passes through the elongated restricting hole and is threadedly connected to the underside of the connecting seat, such that the clutch seat is pivoted about the shaft bolt within the range of the elongated restricting hole.

In one embodiment of the present invention, the coupling plate has a first positioning post, the underside of the connecting seat has a second positioning post, and a spring is connected between the first positioning post and the second positioning post.

In one embodiment of the present invention, a lateral protruding seat is connected to a lower end of one side of the support plate. The lateral protruding seat has a longitudinal pivot hole and a longitudinal elongated through hole. A top of the connecting seat has an upper screw hole and a slot. One side of the connecting seat, parallel to an axial direction of the linear slide rail, has a side hole. The support plate is connected to the connecting seat by a shaft. The shaft has an external thread at one end thereof. The shaft passes through the pivot hole of the lateral protruding seat and is threadedly connected to the upper screw hole of the connecting seat. The elongated through hole is intersected with the slot. A linking bolt having an external thread at one end thereof is provided under the connecting seat. The linking bolt passes through the slot and the elongated through hole of the lateral protruding seat. An adjustable handle nut meshes with the external thread of the linking bolt. Another end of the linking bolt has a horizontal screw hole. An adjustment screw passes through the side hole and is threadedly connected to the horizontal screw hole of the linking bolt. When the adjustment screw is rotated left or right, the linking bolt is driven to move back and forth within the slot, thereby allowing the support plate to pivot synchronously about the shaft.

In one embodiment of the present invention, the first retaining plate has an axial length greater than that of the second retaining plate.

Through the above structure, the position of the support plate can be accurately adjusted by finely adjusting the connecting seat to slide on the linear slide rail in a “mechanical manner” using the rotary handle. The support plate is more stable and does not wobble, achieving better accuracy of the workpiece and better applicability.

### BRIEF DESCRIPTION OF THE DRAWINGS

FIG. 1 is a perspective view of a conventional vertical band saw machine;

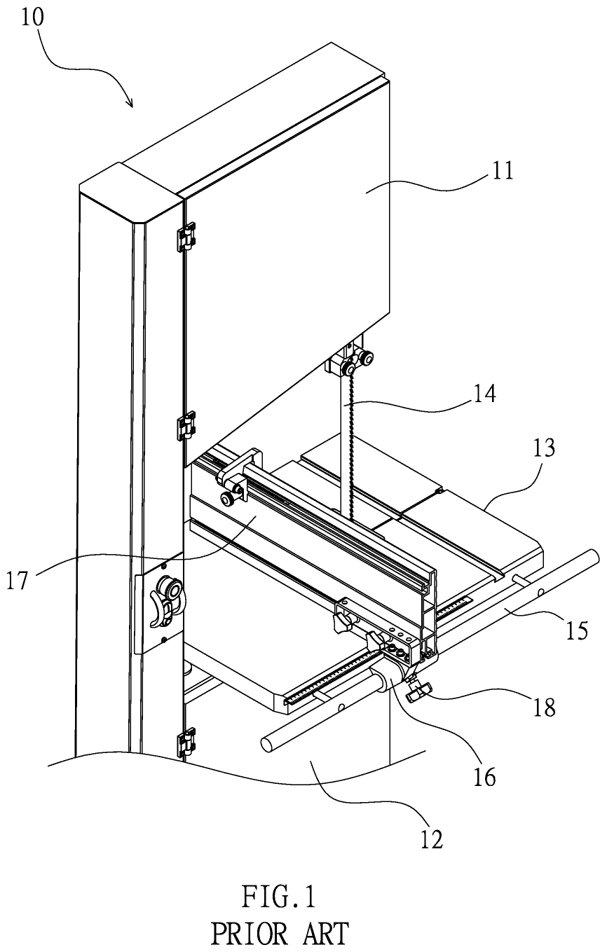

FIG. 2 is a schematic cross-sectional view showing the wobble of the sliding sleeve and the guide rail of the conventional vertical band saw machine;

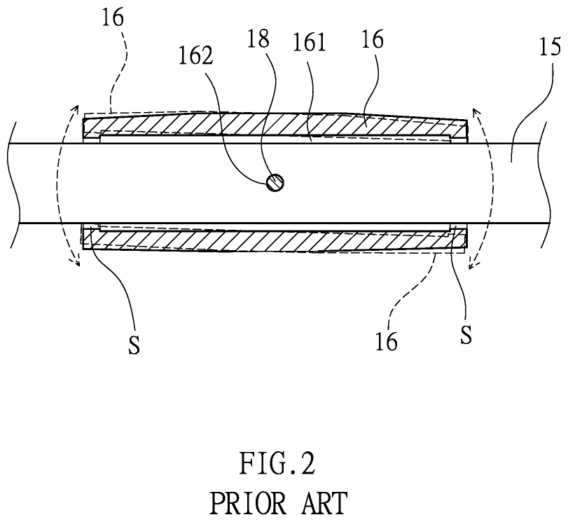

FIG. 3 is an exploded view of the present invention;

FIG. 4 is an exploded view of the retaining plate assembly, the workbench and the rail seat of the present invention;

FIG. 5 is a partial cross-sectional view of the present invention, wherein the worm wheel is not meshed with the serrate portion;

FIG. 6 is a partial cross-sectional view of the present invention, wherein the worm wheel is meshed with the serrate portion; and

FIG. 7 is a partial schematic view of the present invention, wherein the direction of the support plate is calibrated.

### DETAILED DESCRIPTION OF THE PREFERRED EMBODIMENT

Embodiments of the present invention will now be described, by way of example only, with reference to the accompanying drawings.

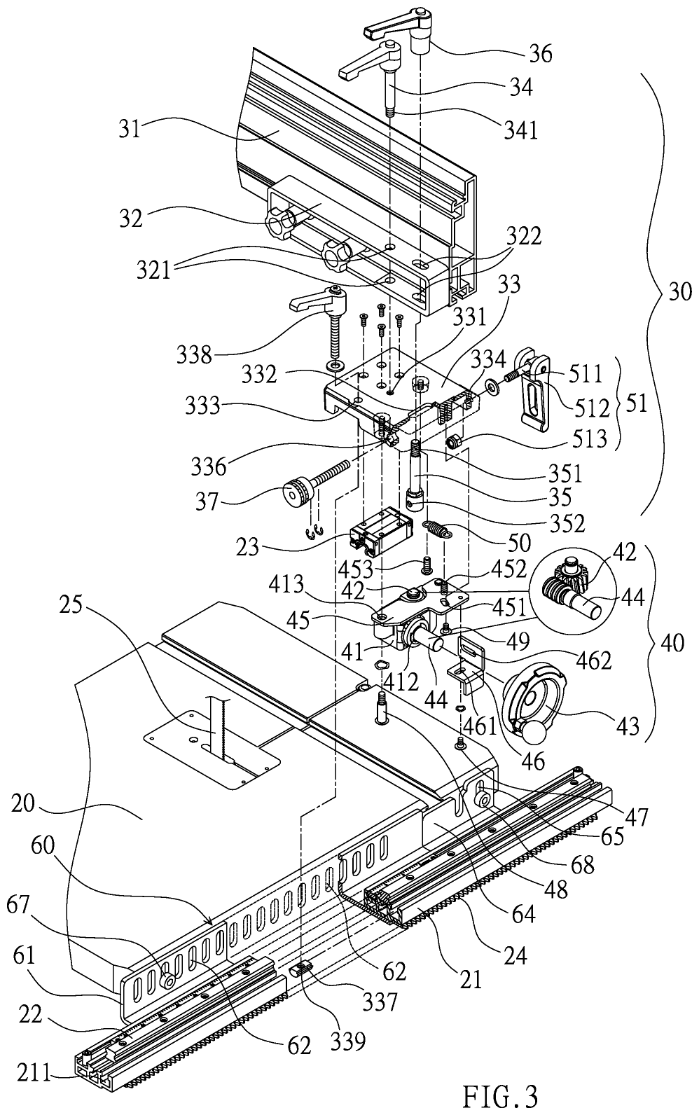

As shown in FIG. 3 through FIG. 7, the present invention discloses a support plate adjustment structure of a vertical band saw machine, comprising a workbench 20 and a support unit 30.

The workbench 20 includes a rail seat 21 having a T-shaped groove 211 fixedly connected to the front side edge of the workbench 20, a linear slide rail 22 on the rail seat 21, and a slide 23 slidably connected to the linear slide rail 22. The front side edge of the rail seat 21 has a serrate portion 24. The T-shaped groove 211, the linear slide rail 22 and the serrate portion 24 are parallel to each other.

A ring-shaped metal band saw blade 25 is driven by power and passes through the workbench 20.

The support unit 30 is connected to the slide 23. The support unit 30 includes a support plate 31 and a connecting seat 33.

The support plate 31 is located above the workbench 20. One side of the support plate 31 faces the ring-shaped metal band saw blade 25. A lateral protruding seat 32 is connected to the lower end of one side of the support plate 31, facing away from the ring-shaped metal band saw blade 25. The lateral protruding seat 32 has a longitudinal pivot hole 321 and a longitudinal elongated through hole 322.

The connecting seat 33 is connected to the slide 23. The top of the connecting seat 33 has an upper screw hole 331, a slot 332, and a positioning hole 333. One side of the connecting seat 33, parallel to the axial direction of the linear slide rail 22, has a shaft hole 334. The other side of the connecting seat 33, parallel to the axial direction of the linear slide rail 22, has a side hole 336. A braking plate 337 is horizontally embedded in the T-shaped groove 211. The braking plate 337 has a plate screw hole 339. An adjustable handle screw 338 is screwed to the plate screw hole 339 from the top of the connecting seat 33 via the positioning hole 333 for locking the braking plate 337 against the T-shaped groove 211 or loosening the braking plate 337 from the T-shaped groove 211, thereby positioning or releasing the connecting seat 33. The support plate 31 is connected to the connecting seat 33 by a shaft 34. The shaft 34 has an external thread 341 at one end thereof. The shaft 34 passes through the pivot hole 321 of the lateral protruding seat 32 and is threadedly connected to the upper screw hole 331 of the connecting seat 33, such that the support plate 31 can be pivoted about the shaft 34. The elongated through hole 322 corresponds to the slot 332 of the connecting seat 33. The elongated through hole 322 is intersected with the slot 332. A linking bolt 35 having an external thread 351 at one end thereof is provided under the connecting seat 33. The linking bolt 35 passes through the slot 332 and the elongated through hole 322 of the lateral protruding seat 32. An adjustable handle nut 36 locks the linking bolt 35 to the lateral protruding seat 32. The other end of the linking bolt 35 has a horizontal screw hole 352. An adjustment screw 37 on the side of the connecting seat 33 passes through the side hole 336 and is threadedly connected to the horizontal screw hole 352 of the linking bolt 35. When the adjustment screw 37 is rotated left or right, the linking bolt 35 will be driven to move back and forth within the slot 332, thereby allowing the adjustment screw 37 to drive the support plate 31 to pivot synchronously about the shaft 34.

A fine adjustment unit 40 is pivoted under the connecting seat 33. The fine adjustment unit 40 includes a clutch seat 41, a worm 44, a rotary handle 43 connected to one end of the worm 44, and a coupling plate 45.

The clutch seat 41 has an opening 411 facing the serrate portion 24 and a side through hole 412 facing away from the opening 411. One side of the clutch seat 41 has a longitudinal perforation 413. A worm wheel 42 is pivoted inside the clutch seat 41 and extends out of the opening 411.

The worm 44 is insertedly connected to the side through hole 412. The worm 44 meshes with the worm wheel 42, so that when the rotary handle 43 is rotated, the worm 44 is driven to rotate the worm wheel 42.

The coupling plate 45 is fixedly connected to the top of the clutch seat 41. The coupling plate 45 has an elongated restricting hole 451. A movable plate 46 is provided on one side of the coupling plate 45 away from the perforation 413. The movable plate 46 is in an “L” shape, and has a horizontal surface and a vertical surface. The horizontal surface has an elongated movement hole 461. The vertical surface has an elongated locking hole 462. A bolt 47 passes through the elongated movement hole 461 from the bottom of the coupling plate 45 and is threadedly connected to the coupling plate 45, so that the movable plate 46 can be pulled within the range of the elongated movement hole 461. The clutch seat 41 is connected to the underside of the connecting seat 33 in cooperation with a shaft bolt 48 passing through the perforation 413 of the clutch seat 41 from the bottom of the clutch seat 41 and a bolt 49 passing through the elongated restricting hole 451 from the bottom of the clutch seat 41, such that the clutch seat 41 and the coupling plate 45 are synchronously pivoted about the shaft bolt 48 within the range of the elongated restricting hole 451 for the worm wheel 42 to mesh or not to mesh with the serrate portion 24. The top of the coupling plate 45 has a first positioning post 452, and the underside of the connecting seat 33 has a second positioning post 453. A spring 50 is connected between the first positioning post 452 and the second positioning post 453. The elongated locking hole 462 of the movable plate 46 corresponds to the shaft hole 334 of the connecting seat 33.

A quick-release locking member 51 includes a screw rod 511, an eccentric rotating handle 512, and a nut 513. One end of the screw rod 511 is pivoted to the eccentric rotating handle 512. The other end of the screw rod 511 passes through the elongated locking hole 462 and the shaft hole 334 of the connecting seat 33, and is then locked with the nut 513. The eccentric rotating handle 512 can be pulled to tighten the clutch seat 41 so that the clutch seat 41 cannot be pivoted, or the eccentric rotating handle 512 can be pulled reversely to loosen the clutch seat 41 so that the clutch seat 41 can be pivoted.

Through the above structure, the position of the support plate 31 can be accurately adjusted by finely adjusting the connecting seat 33 to slide on the linear slide rail 22 in a “mechanical manner” using the rotary handle 43. The support plate 31 is more stable and does not wobble, achieving better accuracy of cutting the workpiece.

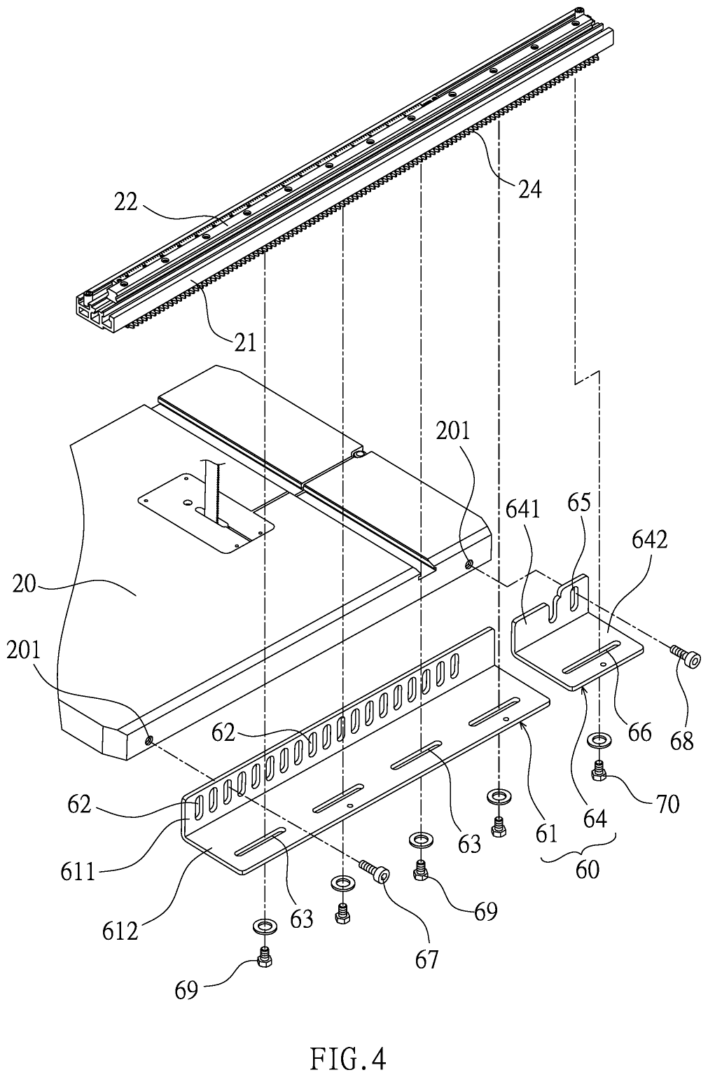

The assembly, function and effect of the above embodiment are described in detail below. As shown in FIG. 3 through FIG. 7, a retaining plate assembly 60 is provided on the front side edge of the workbench 20 of the present invention. The front side edge of the workbench 20 has at least two connecting screw holes 201. The retaining plate assembly 60 includes an L-shaped first retaining plate 61 and an L-shaped second retaining plate 64. The first retaining plate 61 includes a vertical plate 611 and a horizontal plate 612. The vertical plate 611 has a plurality of first elongated vertical holes 62 that are arranged in sequence. The horizontal plate 612 has a plurality of first elongated horizontal holes 63 that are arranged in sequence. The second retaining plate 64 includes a vertical plate 641 and a horizontal plate 642. The vertical plate 641 has at least one second elongated vertical hole 65. The horizontal plate 642 has at least one second elongated horizontal hole 66. The rail seat 21 is disposed on the first elongated horizontal holes 63 and the second elongated horizontal hole 66. The serrate portion 24 extends out of the edge of the retaining plate assembly 60. At least one first transverse bolt 67 passes through a corresponding one of the first elongated vertical holes 62 and is screwed to a corresponding one of the connecting screw holes 201 (as shown in FIG. 4), so that the first relating plate 61 is fixed to the front side edge of the workbench 20. A second transverse bolt 68 passes through the second elongated vertical hole 65 and is screwed to a corresponding one of the connecting screw holes 201, so that the second relating plate 64 is fixed to the front side edge of the workbench 20. The first retaining plate 61 and the second retaining plate 64 are arranged side by side. The rail seat 21 disposed on the horizontal plate 612 of the first retaining plate 61 and the horizontal plate 642 of the second retaining plate 64. At least one first longitudinal bolt 69 passes through a corresponding one of the first elongated horizontal holes 63 and locks the rail seat 21 on the first retaining plate 61. A second longitudinal bolt 70 passes through the second elongated horizontal hole 66 and locks the rail seat 21 on the second retaining plate 64. Preferably, the axial length of the first retaining plate 61 is greater than the axial length of the second retaining plate 64. In this way, the plurality of vertical holes and horizontal holes of the retaining plate assembly 60 composed of two retaining plates with different lengths are applicable to the locking holes of different types of workbenches 20. The first retaining plate 61, the second retaining plate 64 and the rail seat 21 are positioned in a desired position, and then the verticality and horizontality of the rail seat 21 and the linear slide rail 22 are finely adjusted to achieve better applicability.

In the fine adjustment unit 40 of the present invention, the worm wheel 42 and the worm 44 are a transmission mechanism with stable operation and a larger speed reduction ratio. For example, if the worm 44 cooperates with the worm wheel 42 having twenty teeth, the worm 44 rotates 360 degrees and advances only one pitch, while the worm wheel 42 rotates only one tooth. The speed reduction ratio is 20:1. Therefore, as long as the worm wheel 42 is matched with the worm 44 with a suitable reduction ratio, it can play a very good role in adjusting the accuracy of the position of the support plate 31. In addition, when the linear slide rail 22 and the slide 23 are locked and positioned, they are pressed against each other in a plane manner, so they are relatively less prone to wobble, such that the connected support plate 31 can be better stabilized without tilting or swinging.

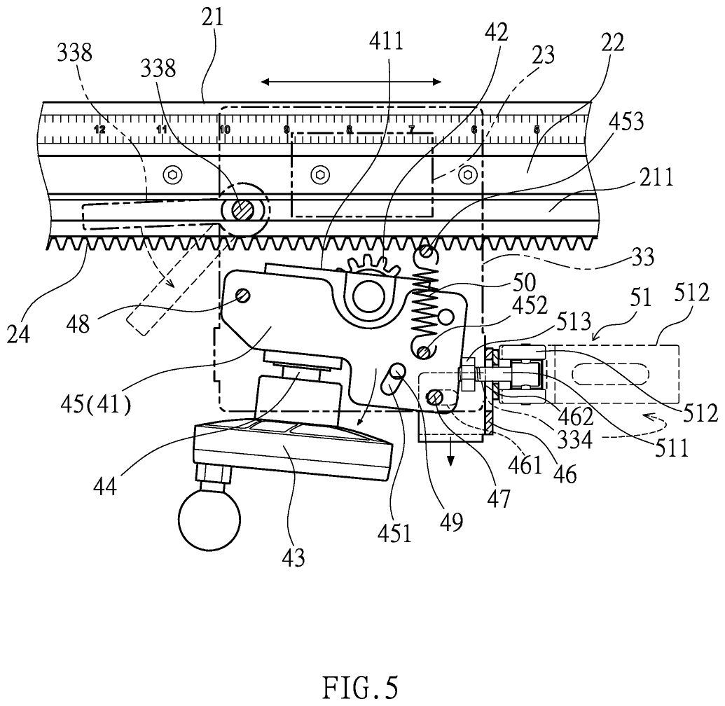

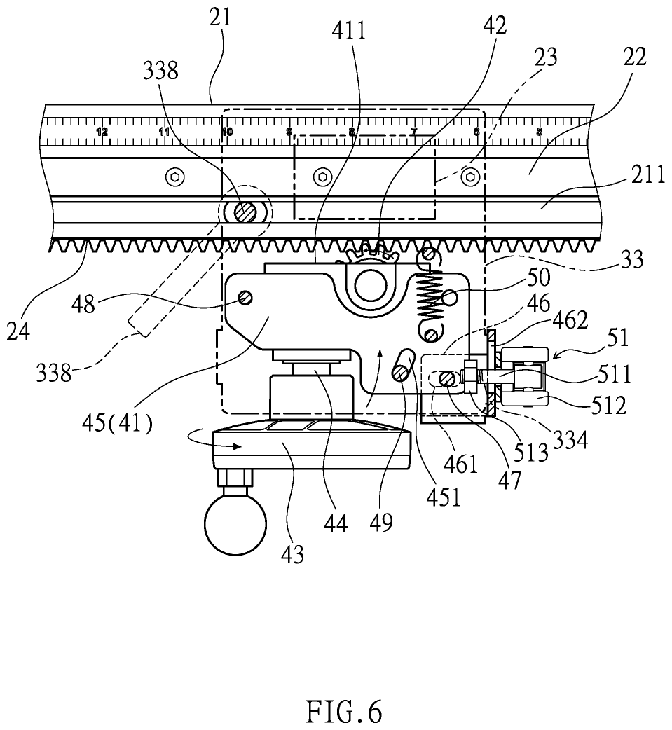

When the position of the support plate 31 needs to be set for cutting a workpiece, the eccentric rotating handle 512 of the quick-release locking member 51 is first pulled to disengage from the elongated locking hole 462 of the movable plate 46. The user pulls the movable plate 46 to move outward along the elongated locking hole 462 (as shown in FIG. 5). At the same time, the movable plate 46 pulls the clutch seat 41 to resist the elastic force of the spring 50 and is pivoted about the shaft bolt 48, so that the worm wheel 42 leaves the serrate portion 24 and is not meshed with the serrate portion 24. The movable plate 46 is pulled outward along the elongated movement hole 461 and turned as the angle of the clutch seat 41 changes. Then, the eccentric rotating handle 512 of the quick-release locking member 51 is pulled to engage with the elongated locking hole 462 of the movable plate 46, so that the clutch seat 41 is kept at an open angle and won't be pulled back by the elastic force of the spring 50. After that, the movable handle screw 338 is rotated to loosen the connecting seat 33, so that the slide 23 is no longer subject to the external force and is free to slide on the linear slide rail 22. Then, the user moves the connecting seat 33 by hand over a long distance, so the connected support plate 31 moves greatly and stays in the approximate position where the workpiece is to be cut. At this time, the eccentric rotating handle 512 of the quick-release locking member 51 is pulled to disengage from the elongated locking hole 462 of the movable plate 46. The elastic force of the spring 50 pulls back the clutch seat 41 quickly, so the worm wheel 42 is meshed with the serrate portion 24 (as shown in FIG. 6). The eccentric rotating handle 512 of the quick-release locking member 51 is pulled again to engage with the elongated locking hole 462 of the movable plate 46, thereby holding the clutch seat 41 to keep the serrate portion 24 and the worm wheel 42 in a meshed state. In this way, the user can rotate the rotary handle 43, and the worm wheel 42 is driven by the worm 44, so that the connecting seat 33 and the slide 23 slide slightly on the linear slide rail 22, thereby causing the connected support plate 31 to change its position. The support plate 31 is slightly adjusted to achieve the setting of a high precision position. Finally, if the position setting of the support plate 31 is completed, the adjustable handle screw 338 can be rotated to lock the connecting seat 33, such that the slide 23 can be positioned on the linear slide rail 22 by the external force, thereby holding the support plate 31, so the support plate 31 cannot be moved. In the locking process, because the worm wheel 42 is meshed with the serrate portion 24 and the worm wheel 42 cannot drive the worm 44 reversely, even if the support plate 31 or the connecting seat 33 is accidentally touched by an external force, it will not be moved inadvertently to ensure that the precision of the processing is not affected.

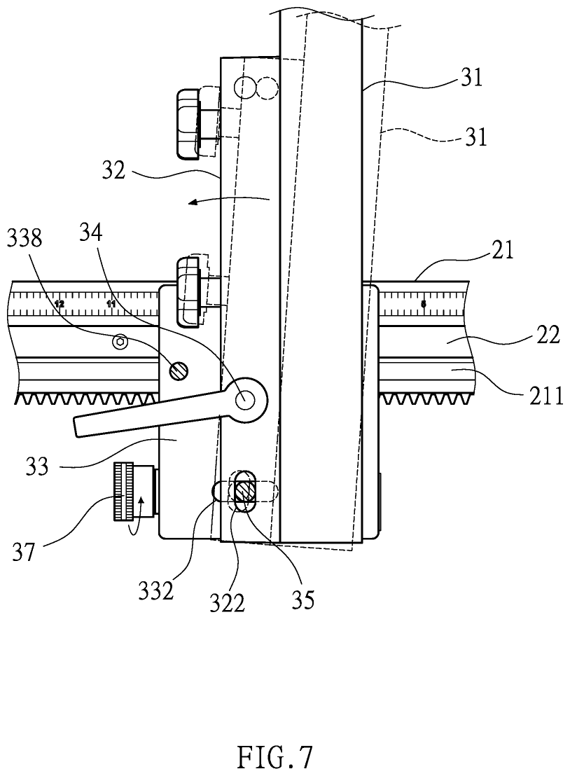

It is worth mentioning that, as shown in FIG. 7, after the workpiece has been cut and processed and it is found that the axial direction of the support plate 31 is not perpendicular to the axial direction of the linear slide rail 22 (for example, due to the fitting tolerance of the linear slide rail 22 and the slide 23), the axial angle of the support plate 31 can be adjusted. During adjustment, the user can rotate the adjustment screw 37 in the side hole 336 freely, so that the horizontal screw hole 352 with which the adjustment screw 37 is screwed is moved with the rotating threads, and the linking bolt 35 drives the support plate 31 to pivot about the shaft 34. In one embodiment of the present invention, when the adjustment screw 37 is rotated clockwise, the support plate 31 is driven to rotate clockwise; when the adjustment screw 37 is rotated counterclockwise, the support plate 31 is driven to rotate counterclockwise, but not limited thereto. By adjusting the angle of the support plate 31, the axial direction of the support plate 31 can be calibrated.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A support plate adjustment structure of a vertical band saw machine, comprising a workbench and a support unit; the workbench including a rail seat fixedly connected to a front side edge of the workbench, a linear slide rail on the rail seat, and a slide slidably connected to the linear slide rail; a front side edge of the rail seat having a serrate portion, a retaining plate assembly being provided between the workbench and the rail seat, the front side edge of the workbench having at least two connecting screw holes, the retaining plate assembly including an L-shaped first retaining plate and an L-shaped second retaining plate; the first retaining plate having a plurality of first elongated vertical holes that are arranged in sequence and a plurality of first elongated horizontal holes that are arranged in sequence; the second retaining plate having at least one second elongated vertical hole and at least one second elongated horizontal hole; the rail seat being disposed on the first elongated horizontal holes and the second elongated horizontal hole, the serrate portion extending out of an edge of the retaining plate assembly, at least one first transverse bolt passing through a corresponding one of the first elongated vertical holes and being screwed to a corresponding one of the connecting screw holes so that the first relating plate is fixed to the front side edge of the workbench; a second transverse bolt passing through the second elongated vertical hole and being screwed to a corresponding one of the connecting screw holes so that the second relating plate is fixed to the front side edge of the workbench, the first retaining plate and the second retaining plate being arranged side by side; at least one first longitudinal bolt passing through a corresponding one of the first elongated horizontal holes and locking the rail seat on the first retaining plate; a second longitudinal bolt passing through the second elongated horizontal hole and locking the rail seat on the second retaining plate; the support unit being connected to the slide, the support unit including a support plate located above the workbench and a connecting seat connected to the slide; the support plate being connected on the connecting seat, a fine adjustment unit being pivoted under the connecting seat, the fine adjustment unit including a clutch seat, a worm and a rotary handle connected to one end of the worm; the clutch seat having a side through hole and an opening facing the serrate portion, a worm wheel being pivoted inside the clutch seat and extending out of the opening; the worm being insertedly connected to the side through hole and meshing with the worm wheel; the clutch seat being pivotally connected to an underside of the connecting seat, the clutch seat being rotatable for the worm wheel to mesh or not to mesh with the serrate portion.

2. The support plate adjustment structure as claimed in claim 1, wherein the rail seat has a T-shaped groove parallel to the rail seat, a top of the connecting seat has a positioning hole, a braking plate is horizontally embedded in the T-shaped groove, the braking plate has a plate screw hole, and an adjustable handle screw is screwed to the plate screw hole from the top of the connecting seat via the positioning hole for locking and loosening the connecting seat, thereby positioning or releasing the connecting seat.

3. The support plate adjustment structure as claimed in claim 1, wherein one side of the connecting seat, parallel to an axial direction of the linear slide rail, has a shaft hole, one side of the clutch seat has a longitudinal perforation, a coupling plate is fixedly connected to a top of the clutch seat, a movable plate is provided on one side of the coupling plate away from the perforation, the movable plate is in an L shape and has a horizontal surface and a vertical surface, the horizontal surface has an elongated movement hole, the vertical surface has an elongated locking hole, a bolt passes through the elongated movement hole and is threadedly connected to the coupling plate; the clutch seat is connected to the underside of the connecting seat in cooperation with a shaft bolt passing through the perforation of the clutch seat, the elongated locking hole corresponds to the shaft hole; a quick-release locking member includes a screw rod, an eccentric rotating handle and a nut, one end of the screw rod is pivoted to the eccentric rotating handle, another end of the screw rod passes through the elongated locking hole and the shaft hole of the connecting seat and is locked with the nut, the eccentric rotating handle is pulled to tighten the clutch seat or the eccentric handle is pulled reversely to loosen the clutch seat.

4. The support plate adjustment structure as claimed in claim 3, wherein the coupling plate has an elongated restricting hole, another bolt passes through the elongated restricting hole and is threadedly connected to the underside of the connecting seat, such that the clutch seat is pivoted about the shaft bolt within the range of the elongated restricting hole.

5. The support plate adjustment structure as claimed in claim 3, wherein the coupling plate has a first positioning post, the underside of the connecting seat has a second positioning post, and a spring is connected between the first positioning post and the second positioning post.

6. The support plate adjustment structure as claimed in claim 1, wherein a lateral protruding seat is connected to a lower end of one side of the support plate, the lateral protruding seat has a longitudinal pivot hole and a longitudinal elongated through hole, a top of the connecting seat has an upper screw hole and a slot, one side of the connecting seat, parallel to an axial direction of the linear slide rail, has a side hole, the support plate is connected to the connecting seat by a shaft, the shaft has an external thread at one end thereof, the shaft passes through the pivot hole of the lateral protruding seat and is threadedly connected to the upper screw hole of the connecting seat, the elongated through hole is intersected with the slot; a linking bolt having an external thread at one end thereof is provided under the connecting seat, the linking bolt passes through the slot and the elongated through hole of the lateral protruding seat, an adjustable handle nut meshes with the external thread of the linking bolt; another end of the linking bolt has a horizontal screw hole, an adjustment screw passes through the side hole and is threadedly connected to the horizontal screw hole of the linking bolt, when the adjustment screw is rotated left or right, the linking bolt is driven to move back and forth within the slot, thereby allowing the support plate to pivot synchronously about the shaft.

7. The support plate adjustment structure as claimed in claim 1, wherein the first retaining plate has an axial length greater than that of the second retaining plate.
